(19) United States
(12) Patent Application Publication
(10) Pub. No.: US 2018/0135344 A1
(43) Pub. Date: May 17, 2018

(54) DOOR HINGE HAVING DAMPING FUNCTION

(71) Applicant: Yelin Liang, Foshan, Guangdong (CN)

(72) Inventor: Yelin Liang, Foshan, Guangdong (CN)

(21) Appl. No.: 15/576,688

(22) PCT Filed: Dec. 1, 2016
(86) PCT No.: PCT/CN2016/108224

§ 371 Date: Nov. 22, 2017

(30) Foreign Application Priority Data
Mar. 4, 2016 (CN) 201610122737.X

(51) Int. Cl. E05F 3/06; E05D 3/14; E05F 3/20

(52) U.S. Cl. CPC E05F 3/06; E05Y 2900/20; E05F 3/20; E05D 3/142

(57) ABSTRACT

A door hinge having a damping function, comprising a housing, a first rotating shaft, a second rotating shaft, a U-shaped rotating shaft, a hinge cup, a linkage member, a torsion spring, a connector, a supporting structure, and a damping structure; one end of the linkage member is rotationally provided in the housing by means of the first rotating shaft, and the other end of the linkage member is rotationally connected to the hinge cup by means of one arm of the U-shaped rotating shaft; one end of the connector is rotationally provided in the housing by means of the second rotating shaft, and the other end of the connector is rotationally connected to the hinge cup by means of the other arm of the U-shaped rotating shaft; the torsion spring is fitted over the second rotating shaft.

### TECHNICAL FIELD OF THE INVENTION

The present invention relates to the technical field of hinges, and more particularly, to a door hinge having a damping function.

### BACKGROUND OF THE INVENTION

A traditional door hinge having a damping function usually comprises a housing, a first rotating shaft, a U-shaped rotating shaft, a hinge cup, a connector, a linkage member, a pusher and a damping cylinder. The piston rod of the damping cylinder is rotationally connected to the pusher, and the pusher is connected to the linkage member. Such a design has a very complicated structure. In particular, during use, the pusher is pulled by the piston rod of the cylinder to achieve a damping effect. In such a configuration, the piston rod fails to move in the axial direction, resulting in a greater friction between the piston rod and the sealing ring of the cylinder. Consequently, oil leakage can easily occur after a prolonged use, leading to problems such as hinge failure, difficult maintenance and low precision of the door hinge, resulting in a shortened life span.

### SUMMARY OF THE INVENTION

The purpose of the present invention is to solve the shortcomings in the prior art and provide a door hinge having a damping function that enables the piston rod to move in the axial direction, can be easily assembled and maintained, has a simple structure, a long life-span and a high precision.

To achieve the above purpose, the present invention adopts the following technical solution: A door hinge having a damping function, comprising a housing, a first rotating shaft, a second rotating shaft, a U-shaped rotating shaft, a hinge cup, a linkage member, a torsion spring, a connector, a supporting structure, and a damping structure; one end of the linkage member is rotationally provided in the housing by means of the first rotating shaft, and the other end of the linkage member is rotationally connected to the hinge cup by means of one arm of the U-shaped rotating shaft; the hinge cup is fixed to the door plank; one end of the connector is rotationally provided in the housing by means of the second rotating shaft, and the other end of the connector is rotationally connected to the hinge cup by means of the other arm of the U-shaped rotating shaft; the torsion spring is fitted over the second rotating shaft, one end of the torsion spring is fixed to the linkage member, and the other end of the torsion spring abuts against the linkage member; the supporting structure is fixed to the linkage member; the damping structure is supported by the supporting structure and moves in the housing along with the supporting structure; a piston rod of the damping structure can abut against the torsion spring, thereby increasing the resetting resistance to the torsion spring.

The supporting structure comprises two left support arms and two right support arms. The left support arm coordinates with the right support arm to form a V-shaped mounting slot. The damping structure is disposed in the mounting slot formed between the left support arm and the right support arm.

The damping structure is a round-shaped cylinder body. The two sides of the round-shaped cylinder body are respectively provided with a locking block. The locking block is disposed in the mounting slot formed between the left support arm and the corresponding right support arm.

Compared with the prior art, the present invention has a simple structure, a long life-span and a high precision, and can be conveniently maintained.

### BRIEF DESCRIPTION OF THE DRAWINGS

FIG. 1 is an exploded view of the present invention;

FIG. 2 is a three-dimensional diagram of the present invention;

FIG. 3 is a top view of the present invention;

FIG. 4 is a sectional view illustrating one state of portion A-A in FIG. 3;

FIG. 5 is a sectional view illustrating another state of portion A-A in FIG. 3;

FIG. 6 is a three-dimensional diagram of the present invention without the housing; and

FIG. 7 is a bottom view of the present invention.

### DETAILED DESCRIPTION OF THE INVENTION

Drawings and detailed embodiments are combined hereinafter to elaborate the technical principles of the present invention.

The terms “front”, “rear”, “left”, “right”, and similar ones used below do not imply a required limitation in all embodiments of the present invention, but are used herein to describe relative direction or orientation in exemplary embodiments illustrated in the figures.

Furthermore, the terms “first” and “second” are merely used for descriptive purpose, which should neither be seen as an indication or implication of a relative importance, nor be seen as that of the quantity of the technical features.

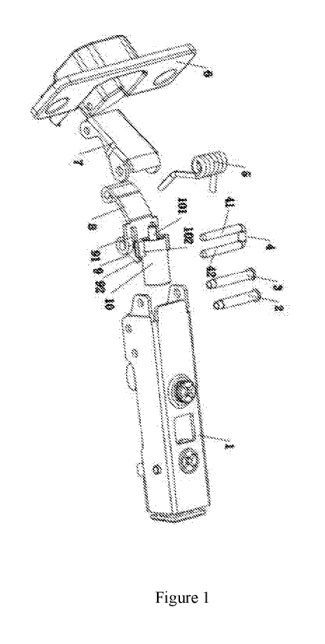

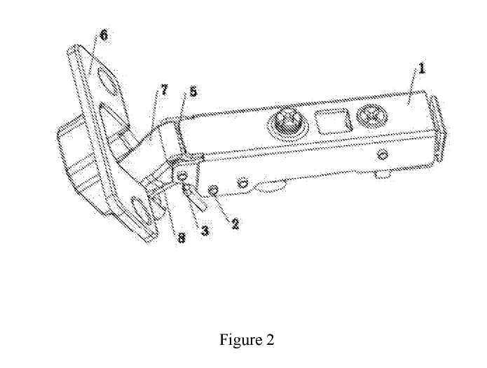

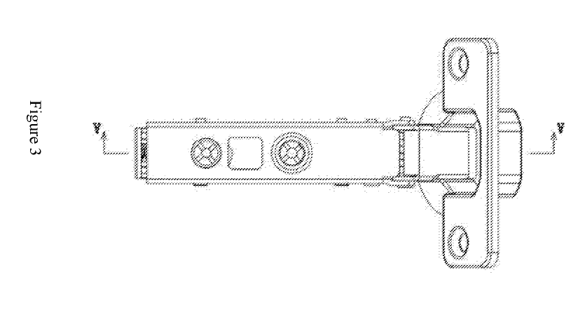

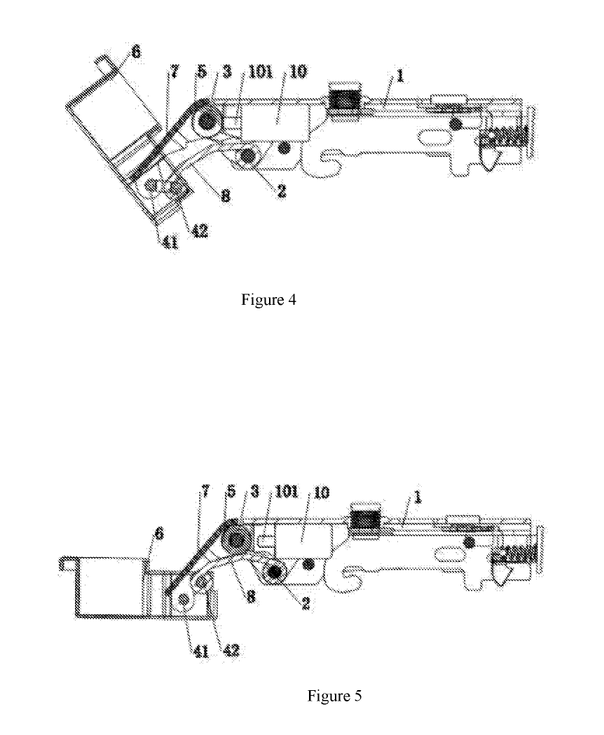

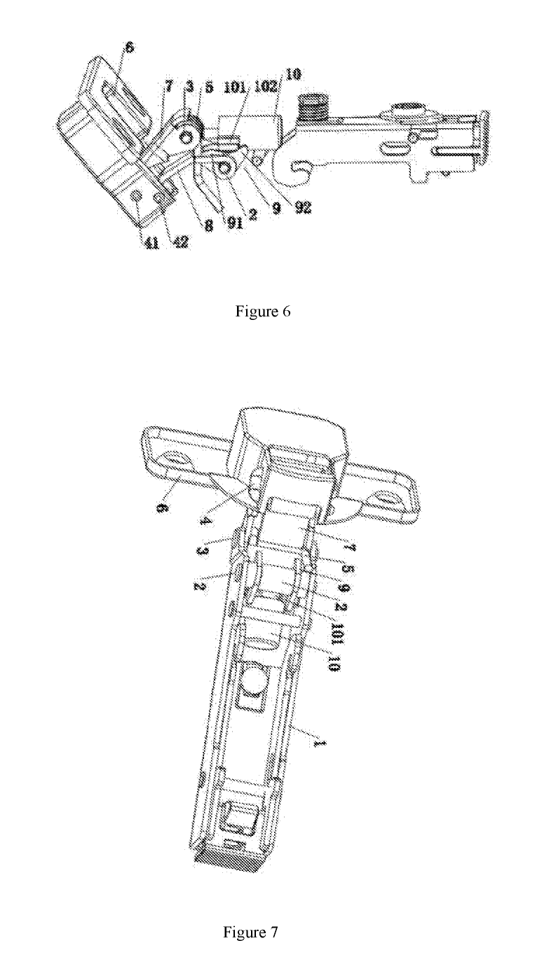

As shown in FIGS. 1-7, the door hinge having a damping function comprises a housing 1, a first rotating shaft 2, a second rotating shaft 3, a U-shaped rotating shaft 4, a hinge cup 6, a linkage member 8, a torsion spring 5, a connector 7, a supporting structure 9, and a damping structure 10; one end of the linkage member 8 is rotationally provided in the housing 1 by means of the first rotating shaft 2, and the other end of the linkage member 8 is rotationally connected to the hinge cup 6 by means of one arm 42 of the U-shaped rotating shaft 4; the hinge cup 6 is fixed to the door plank; one end of the connector 7 is rotationally provided in the housing 1 by means of the second rotating shaft 3, and the other end of the connector 7 is rotationally connected to the hinge cup 6 by means of the other arm 41 of the U-shaped rotating shaft 4; the torsion spring 5 is fitted over the second rotating shaft 3, one end of the torsion spring 5 is fixed to the linkage member 8, and the other end of the torsion spring 5 abuts against the linkage member 8; the supporting structure 9 is fixed to the linkage member 8; the damping structure 10, which is disposed in the housing 1, is supported by the supporting structure 9 and moves in the housing 1 along with the supporting structure 9; a piston rod 101 of the damping structure 10 can abut against the torsion spring 5, thereby increasing the resetting resistance to the torsion spring 5.

During use, when the door is closed, the linkage member 8 rotates, and the supporting structure 9 moves along with the linkage member 8. Thus, the supporting structure 9 propels the damping structure 10 to move towards the direction of the torsion spring 5. The piston rod 101 of the damping structure 10 abuts against the torsion spring 5, thereby decreasing the resetting torque of the torsion spring 5. Consequently, the closing force of the door can be reduced and the closing speed can be lowered, thereby achieving a damping effect. Thus, the door plank can be slowly closed. When the door is open, the linkage member 8 moves towards a reverse direction, and the supporting structure 9 moves along the linkage member 8. The supporting structure 9 propels the damping structure 10 to move towards a direction far from the torsion spring 5. Consequently, the piston rod 101 of the damping structure 10 no longer abuts against the torsion spring 5. Thus, the torsion spring 5 works normally, and the door can be open.

In this embodiment, the supporting structure 9 comprises two left support arms 91 and two right support arms 92. The two left support arms 91 and the two right support arms are symmetrically disposed on the linkage member 8. The left support arm 91 coordinates with the corresponding right support arm 92, thereby forming a V-shaped mounting slot. The damping structure 10 is disposed in the V-shaped mounting slot formed between the left support arm 91 and the corresponding right support arm 92. During use, when the linkage member 8 rotates clockwise, the right support arm 92 abuts against the damping structure, and the supporting structure 9 moves leftward; when the linkage member 8 rotates counter-clockwise, the left support arm 91 abuts against the damping structure 10, and the supporting structure 9 moves rightward.

In this embodiment, the damping structure 10 is a round-shaped cylinder body. The two sides of the round-shaped cylinder body are respectively provided with a locking block 102. The locking block 102 is disposed in the mounting slot formed between the left support arm 91 and the corresponding right support arm 92.

The description of the above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. A door hinge having a damping function, comprising:
a housing,
a first rotating shaft,
a second rotating shaft,
a U-shaped rotating shaft,
a hinge cup,
a linkage member,
a torsion spring,
a connector,
a supporting structure, and
a damping structure, wherein one end of the linkage member is rotationally provided in the housing by mean of the first rotating shaft, and the other end of the linkage member is rotationally connected to the hinge cup by means of one arm of the U-shaped rotating shaft, wherein the hinge cup is fixed on the door plank, wherein one end of the connector is rotationally provided in the housing by means of the second rotating shaft, and the other end of the connector is rotationally connected to the hinge cup by means of the other arm of the U-shaped rotating shaft, wherein the torsion spring is fitted over the second rotating shaft, one end of the torsion spring is fixed to the linkage member, and the other end of the torsion spring abuts against the linkage member, wherein the supporting structure is fixed to the linkage member, wherein the damping structure is supported by the supporting structure and moves in the housing along with the supporting structure, wherein a piston rod of the damping structure can abut against the torsion spring, thereby increasing the resetting resistance to the torsion spring.

2. The door hinge having a damping function of claim 1, wherein the supporting structure comprises two left support arms and two right support arms, wherein the left support arm coordinates with the right support arm to form a V-shaped mounting slot, wherein the damping structure is disposed in the mounting slot formed between the left support arm and the right support arm.

3. The door hinge having a damping function of claim 2, wherein the damping structure is a round-shaped cylinder body, wherein the two sides of the round-shaped cylinder body are respectively provided with a locking block, wherein the locking block is disposed in the mounting slot formed between the left support arm and the corresponding right support arm.
